(19) United States
(12) Patent Application Publication
(10) Pub. No.: US 2024/0371188 A1
(43) Pub. Date: Nov. 7, 2024

(54) SYSTEMS AND METHODS FOR MANAGING DIGITAL NOTES FOR PROJECT PLANNING

(71) Applicant: 3M INNOVATIVE PROPERTIES COMPANY, Saint Paul, MN (US)

(72) Inventors: Nathaniel D. Anderson, St. Paul, MN (US); Caitlin M. Race, Stillwater, MN (US); Paul A. Kendrick, North Oaks, MN (US); Patrick S. Bowden, Santa Monica, CA (US); Orlin B. Knudson, Vadnais Heights, MN (US)

(21) Appl. No.: 18/552,564

(22) PCT Filed: Mar. 28, 2022
(86) PCT No.: PCT/IB2022/052853

§ 371 Date: Sep. 26, 2023

Related U.S. Application Data
(60) Provisional application No. 63/178,742, filed on Apr. 23, 2021.

(51) Int. Cl. G06V 30/196; G06V 10/56; G06V 20/62; G06V 20/70

(52) U.S. Cl. CPC G06V 30/1983; G06V 10/56; G06V 20/63; G06V 20/70

(57) ABSTRACT

A method of managing notes for project planning such as the Scrum methodology. The method obtains a digital image of a board having physical notes with task information and point values. The notes in the digital image are separated, and handwriting in the notes is converted to corresponding character strings for the task information and point values. A color is detected for each of the notes in order to create color-coded groups of the notes. The method outputs the color-coded groups with the corresponding character strings, which can be used to generate charts relating to the Scrum board.

### BACKGROUND

In the Scrum methodology, a set of tasks that a team must complete is collected in one location called a backlog. These tasks are often recorded on repositionable paper notes. The tasks typically include an estimate of the effort needed for completion called points. The team addresses these tasks over a fixed time period called a sprint. To plan which tasks from the backlog will be addressed in the sprint, a planning meeting is held. At this meeting, a point target for the sprint is determined, and the team moves a number of tasks from the backlog into the scope of the sprint so that the total number of points is equal to that target. Determining whether the team has achieved the target typically involves repeated summing as the plan is discussed. For instance, there are usually dozens of separate notes with varying point values. Given that the tasks are recorded on paper notes, a need exists for a way to digitize the notes for electronically processing the information recorded on them.

### SUMMARY

A method of managing notes for project planning includes obtaining a digital image of a board having a plurality of individual notes with each of the notes representing a physical note. The notes in the digital image are separated, and handwriting in the notes is converted to corresponding character strings. A color is detected for each of the notes in order to create color-coded groups of them. The method outputs the color-coded groups with the corresponding character strings, which can be used to generate charts relating to the board of notes.

### BRIEF DESCRIPTION OF THE DRAWINGS

FIG. 1 is a diagram of an exemplary computer system for managing digital notes for project planning.

FIG. 2 illustrates an example of a Scrum board.

FIG. 3 shows an exemplary note representing a task in a Scrum framework and a point value for the task.

FIG. 4 is a flow chart of a process for managing digital notes for project planning.

FIG. 5 illustrates visualization of computer vision processing steps for the project planning process.

FIG. 6 illustrates markings on notes to identify areas where point values should be written.

FIG. 7 shows examples of Scrum charts that can be generated using the project planning system and process.

### DETAILED DESCRIPTION

Embodiments include a system and methods to assist with project planning in the Agile Project Management (PLANVIEW, Inc.) framework, for example. The system uses a camera and computer vision algorithms to recognize physical (e.g., paper) notes and digitize handwritten numbers (or other content) on them and then can display summary statistics and charts based on grouping by note color. This system combines the advantages of physical notes for Agile Project Management (flexibility and promoting group discussion) with some of the benefits of software tools for project management (automated tracking and summary reports).

The function of this software is to speed up the planning process by automatically summing the points. Furthermore, by recognizing note color, the system can display sums broken down by color-coded categories in order to tell at a glance how much time is being devoted to different goals (e.g., epics in the Scrum framework). The system could be useful for any company or entity using the Scrum method with paper repositionable notes rather than online tools (e.g., the JIRA product management software product). The system could also be useful for other types of project planning based upon recorded tasks and related information.

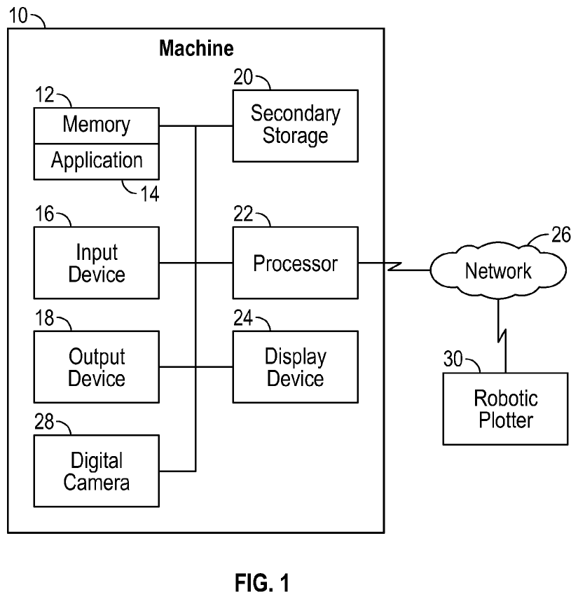

FIG. 1 is a diagram of an exemplary machine 10 for managing digital notes for project planning, for example Scrum methodology or other projects having tasks. Machine 10 can include, for example, the following components: a memory 12 storing one or more applications 14; a secondary storage 20 for providing non-volatile storage of information; an input device 16 for entering information or commands into machine 10; a processor 22 for executing applications stored in memory 12 or secondary storage 20, or as received from another source; an output device 18 for outputting information, such as a printer for providing hard copies of information in printed form or speakers for providing information in audio form; a display device 24 for electronically displaying information in visual or audiovisual form; and a digital camera 28 or other image capture device for capturing digital images. Machine 10 can include a connection to a network 26 such as the Internet, an intranet, or other type of network. The system can also include a robotic plotter 30 electronically connected with machine 10 via network 26.

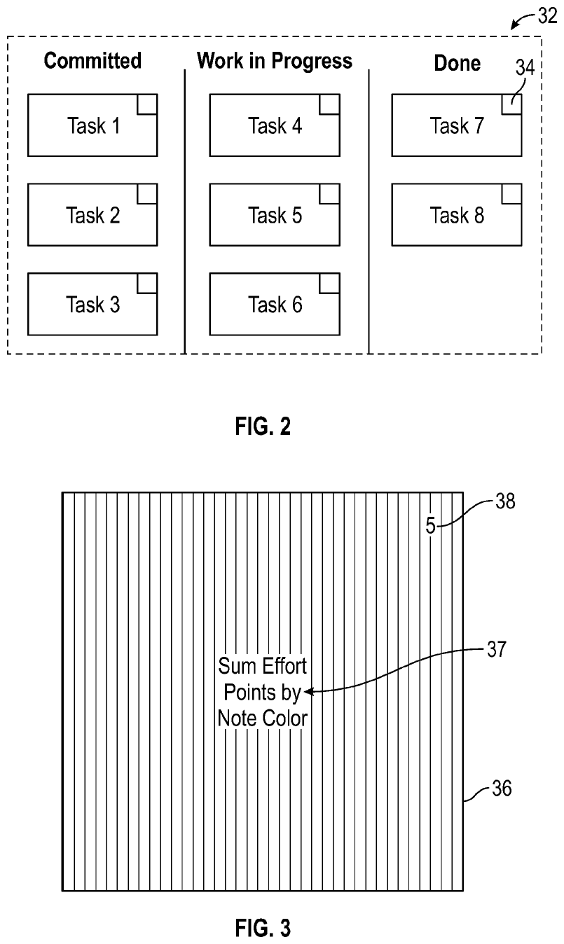

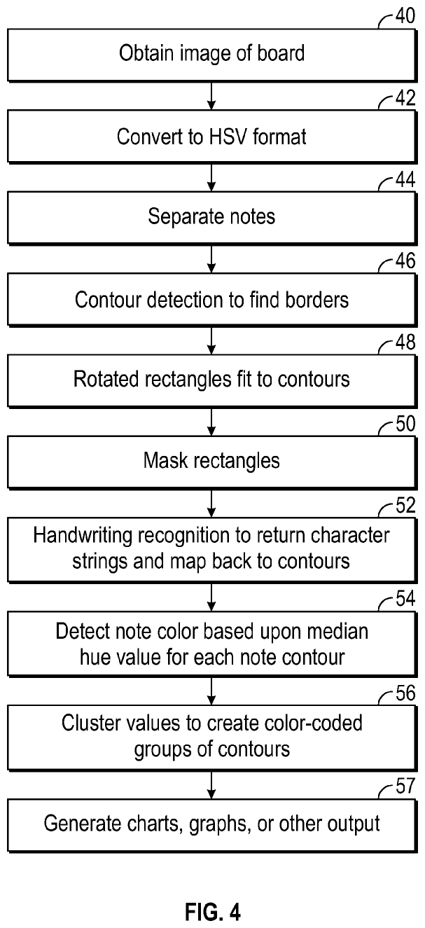

The system processes digital images of Scrum boards, as illustrated in FIG. 2, using real-time video or stills from a web camera or an image file. The exemplary Scrum board 32 in FIG. 2 shows notes having tasks written on them and including point values in the corners 34 of the notes. Categories for the notes are typically indicated by note color, but alternately could be indicated with text or a symbol in a predetermined location on the note. FIG. 3 shows an example of a note 36 in the Scrum framework. In the top right corner 38 is a number (e.g., the number 5 as shown) representing the point value of the task. The text 37 in the center of the note (“Sum Effort Points by Note Color”) is the description of the task to be performed.

In one embodiment for example, the software application for the project planning can run on a personal computer with a USB web camera and have an Internet connection in order to use the MICROSOFT Azure cloud services for the handwriting recognition model. In another embodiment, the software application can run on the Raspbian operating system (The Raspberry Pi Foundation) on a small Linux operating system single board computer mounted in a small, custom portable box to be mounted on a white board (the Scrum board). Other embodiments can run on a mobile phone or tablet computer.

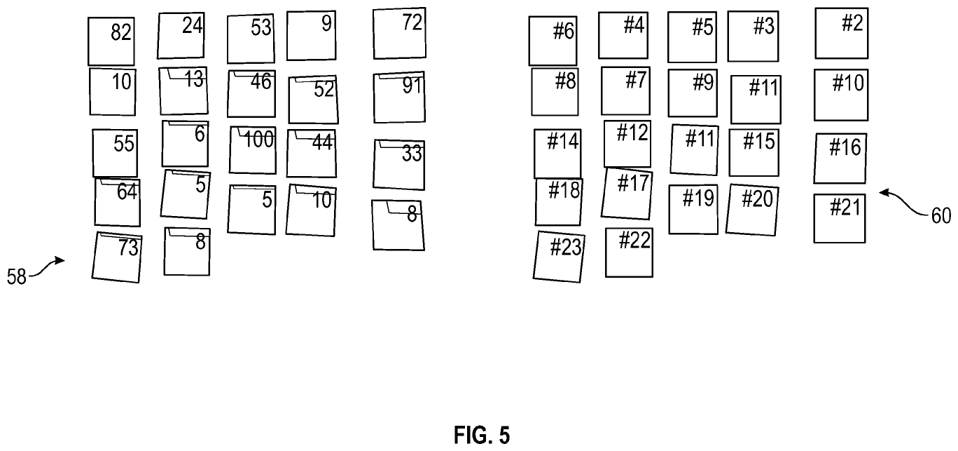

FIG. 4 is a flow chart of a process for managing digital notes for project planning, for example the Scrum methodology. This process can be implemented in software or firmware for execution by a processor such as processor 22.

An image of the board of notes such as a Scrum board (step 40) is converted into Hue/Saturation/Value (HSV) format (step 42). Saturation is used to separate notes from the background; in one implementation, the notes are assumed to be on a whiteboard, so regions with low saturation values are likely to be part of the background. Individual notes are segmented using a watershed algorithm, which separates the shapes even if they overlap on the board (step 44). Contour detection is used to find the borders of the notes (step 46), then rotated rectangles are fit to the contours (step 48). Masking is applied to each rectangle in order to hide or obscure the content except the top right corner (step 50), where the point value is expected to be located. Alternatively, the masking can hide or obscure the content except other areas of the notes, such as other corners or other locations. This masked image is then sent to the handwriting detection model (e.g., the MICROSOFT Azure Computer Vision API), which returns character strings in bounding boxes, which are mapped back on to the note contours in the local application (step 52). Note colors are based on the median Hue value for each note contour (step 54). These values are clustered using the DBSCAN algorithm in order to create color-coded groups of contours (step 56). Clustering is used for grouping because median hue can vary slightly between notes of the same color depending on lighting conditions, location on whiteboard, or other factors. Charts or other output can be generated using the results of the process (step 55).

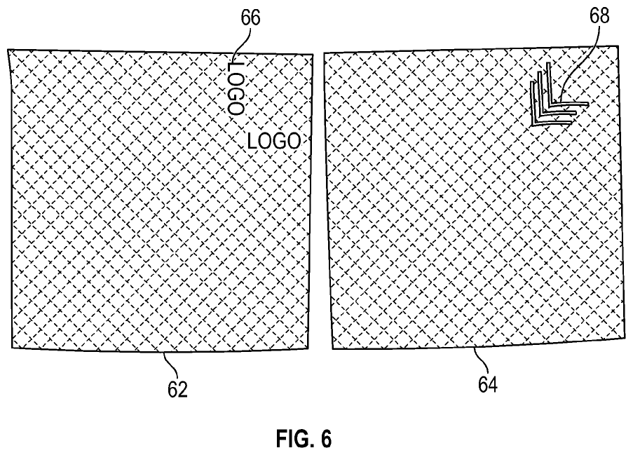

The software can rely on computer vision algorithms implemented in the Open Source Computer Vision (OpenCV) library. FIG. 5 illustrates visualization of computer vision processing steps in the process of FIG. 4. On left (58), the image is masked to remove the background, using color saturation, morphological operations, and the watershed algorithm. The notes in this left image (58) would have visible shadows causing different hue values, as represented by the lines on the notes. On the right (60), the result of finding contours, fitting rotated rectangles, and filling contours with the median hue is shown. Overlaid numbers are contour labels, showing that the individual notes have been separated. Also, this right diagram (60) represents the shadow-covered note photos from the left image (58) being replaced by solid rectangles filled with the median hue values. The methods to extract notes can also or alternatively use an image capture engine such as the one disclosed in U.S. Pat. No. 9,070,036.

In another implementation, a robotic plotter arm 30 (see FIG. 1) can optionally be used to create a physical copy of a Scrum board in a remote location in order to maintain physical copies of the Scrum board for distributed teams (step 57). Computer vision could then be used to identify the note arrangement and the text on the notes, while the plotter would be used to recreate the notes and a separate robotic arm could place the notes on a board.

Other implementations can include error checking to improve robustness when using the real-time video feed, for example processing multiple frames and displaying the average or running mode of n video frames, creating composite images of cropped corners over multiple frames to find the best estimate of the number, or prompting a user to adjust the camera if results are not adequate.

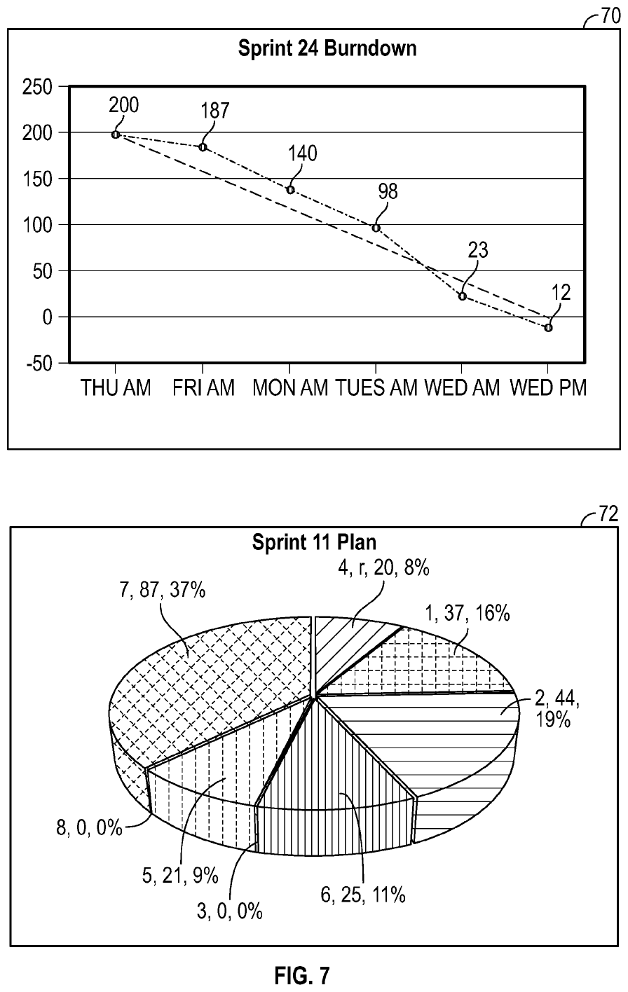

Another implementation of the system can tie the software functionality to Scrum notes with special markings to indicate where different pieces of information should be written. For example. FIG. 6 shows markings to identify areas on notes where point values should be written. A note 62 includes logos 66 such as a company logo and a note 64 shows lines 68, in both cases indicating a location for the point values.

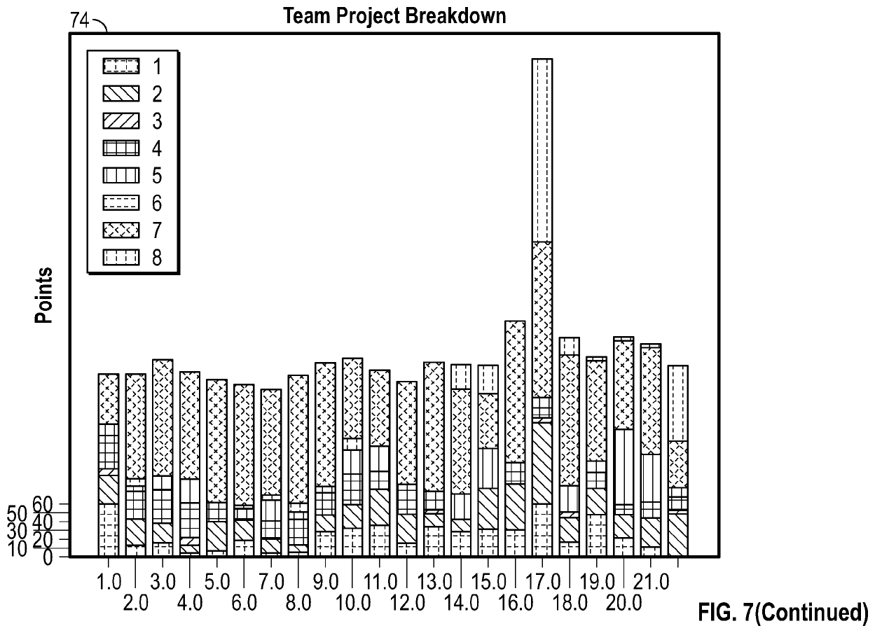

In addition to sprint planning, the system could be used to analyze the results at the end of each sprint and create a burn-down chart and other summary statistics. FIG. 7 shows examples of Scrum charts that can be created by digitizing note color, point total, and location on the Scrum board. A burndown chart 70 shows progress toward the sprint goal by day. A chart 72 shows point allocation to sub-goals or epics. A chart 74 shows point allocation to epics in past sprints. In addition to tracking the point value and color of each note, the location of the note in a grid on the board could be used to group tasks by priority (e.g., high priority tasks on top) or track when each task was completed (e.g., day 1 in column 1, day 2 in column 2, and so on).

Furthermore, the system can perform handwriting recognition on the whole note and save task information, epic name, who the task was assigned to, and other information. This information could be stored in a spreadsheet or database to help with maintaining records. Such a database could be used to automatically calculate the target number of points for planning based on the number of points completed in previous sprints. This target number could then be displayed on the screen of the whiteboard-mounted system for reference during planning. This database system could also be used to synchronize a physical Scrum board with separate project planning software (e.g., the JIRA product management software product) for remote users or project archiving.

In another implementation, a laser or plurality of lasers can be included in the system in order to highlight notes. Using these lasers, the system could make suggestions during planning about which notes to remove in order to achieve the target point total. This integrated system can also include lighting (e.g., a flash) in order to improve image capture of the notes with lighting consistency for improved note and number recognition.

1. A method comprising:
obtaining a digital image of a board having a plurality of individual notes, wherein each of the individual notes represents a physical note;
separating the notes in the digital image;
converting handwriting in the notes to corresponding character strings;
detecting a color for each of the notes;
creating color-coded groups of the separated notes based upon the detected colors; and
outputting the color-coded groups with the corresponding character strings.

2. The method of claim 1, further comprising separating the notes from a background in the image.

3. The method of claim 2, wherein the separating the notes from the background comprises converting the digital image into a hue/saturation/value format.

4. The method of claim 1, wherein separating further comprises segmenting the notes.

5. The method of claim 4, further comprising using contour detection to find a border of each of the notes.

6. The method of claim 5, further comprising fitting rectangles to the border of each of the notes.

7. The method of claim 6, further comprising applying masking to each of the rectangles to hide a content of each of the notes except a particular area of the notes.

8. The method of claim 7, wherein converting further comprises converting the handwriting from only the particular area of the notes.

9. The method of claim 1, wherein detecting further comprises detecting the color based upon a median hue value for each of the notes.

10. The method of claim 1, wherein converting further comprises converting the character strings into point values for the corresponding notes.

11. The method of claim 1, further comprising generating charts based upon the color-coded groups and the corresponding character strings.

12. The method of claim 1, wherein obtaining further comprises obtaining an image of a Scrum board.

13. The method of claim 1, wherein each of the notes has markings indicating a location of handwriting to be converted.

14. The method of claim 13, wherein the markings comprise lines in a corner of the notes.

15. The method of claim 13, wherein the markings comprise one or more logos in a corner of the notes.

16. The method of claim 1, further comprising sending the color-coded groups with the corresponding character strings to a robotic plotter for use in re-creating the board.

17. The method of claim 1, wherein converting further comprises converting the handwriting representing task information.

18. (canceled)

19. A computing device comprising:
at least one memory; and
at least one processor coupled to at least one of the at least one memory, the at least one processor being configured to perform operations to:
obtain a digital image of a board having a plurality of individual notes, wherein each of the individual notes represents a physical note;
separate the notes in the digital image;
convert handwriting in the notes to corresponding character strings;
detect a color for each of the notes;
create color-coded groups of the separated notes based upon the detected colors; and
output the color-coded groups with the corresponding character strings.

20. At least one non-transitory computer-readable memory encoded with instructions that, when executed, configure at least one processor for:
obtaining a digital image of a board having a plurality of individual notes, wherein each of the individual notes represents a physical note;
separating the notes in the digital image;
converting handwriting in the notes to corresponding character strings;
detecting a color for each of the notes;
creating color-coded groups of the separated notes based upon the detected colors; and
outputting the color-coded groups with the corresponding character strings.
